(19) United States
(12) Patent Application Publication
(10) Pub. No.: US 2020/0355108 A1
(43) Pub. Date: Nov. 12, 2020

(54) VEHICLE POLLUTANT EMISSIONS MEASUREMENT METHOD USING AN ON-BOARD SYSTEM

(71) Applicant: IFP Energies nouvelles, Rueil-Malmaison (FR)

(72) Inventors: Sol Selene RODRIGUEZ RODRIGUEZ, RUEIL-MALMAISON CEDEX (FR); Laurent THIBAULT, RUEIL-MALMAISON CEDEX (FR); Philippe DEGEILH, RUEIL-MALMAISON CEDEX (FR); Joseph KERMANI, RUEIL-MALMAISON CEDEX (FR); Arnaud FROBERT, RUEIL-MALMAISON CEDEX (FR)

(21) Appl. No.: 16/871,808

(22) Filed: May 11, 2020

(30) Foreign Application Priority Data
May 10, 2019 (FR) 19/04.858

(51) Int. Cl. F01N 11/00; F01N 3/10; G07C 5/08; G07C 5/00

(52) U.S. Cl. CPC F01N 11/00; F01N 3/101; F01N 2550/02; G07C 5/0816; G07C 5/008; F01N 3/103

(57) ABSTRACT

The present invention is a method of determining emissions of vehicle pollutants using an on-board measurement system with a sensor (CAP) and a computer system including a generic model (MOD GEN) of the vehicle. The method is based on the use of the measurements and of the model for determining the amount of pollutants.

### CROSS-REFERENCE TO RELATED APPLICATIONS

Reference is made to French Patent Application No. 19/04.858, filed May 10, 2019, the contents of which are incorporated herein by reference in their entirety.

### BACKGROUND OF THE INVENTION

### Field of the Invention

The present invention relates to the field of determining vehicle pollution emissions.

Emissions of private cars are a matter of concern to the general public and to lawmakers. Indeed, the latest cases (Dieselgate and its developments) have appropriately discredited the car industry by showing that some car manufacturers had been dishonest over emission control. It has been proven that different settings had been used for determining emissions for compliance with emission standards and in real-world use.

### Description of the Prior Art

In order to address these concerns and to avoid more scandals, the vehicle emission compliance standard has been changed by bringing it closer to reality (WLTC cycle: Worldwide harmonized Light vehicles Test Procedures) and by systematically comparing the emissions obtained under laboratory conditions and under real conditions (RDE: Real Driving Emissions). Measurement systems that can be taken on board a private car and/or a transport vehicle have therefore been developed. These devices, referred to as PEMS (Portable Emissions Measurement System), are bulky, expensive, fragile and require significant maintenance work because they must meet the precision criteria defined by the standard. They are thus designed to be used only by specialists, either during the development of a vehicle or upon a homologation applied standard for vehicle emissions.

Furthermore, emission determination methods using models without sensors have been developed. Patent application FR-3,049,653 (WO-17,174,239) describes such a model-based method. Although satisfactory in terms of speed, ease of use and representativeness (the models are constructed with parameters of the vehicle), the method cannot take into account specific features of each vehicle which are notably those related to control and calibration strategies. It is not sufficient in itself without a measurement system to determine emissions within this car market surveillance context.

To overcome these drawbacks, patent application FR-18/51,330 concerns an on-board vehicle emissions measurement system. The on-board measurement system comprises at least one sensor arranged downstream from the after-treatment system, and optionally a sensor plugged into the vehicle OBD (On-Board Diagnostics) port, as well as computer including models. According to the invention, determination of pollution emissions is based on the signal from the sensor and on the models. Using models account for the signal of at least one sensor allows obtaining precise and representative emissions determination. Furthermore, using models enables the number of sensors to be limited, which allows limiting the cost and maintenance of the on-board measurement system, and provides simplicity of use. However, this on-board system does not allow measurement of an amount by determination of the mass of emissions. Indeed, it allows measurement of an amount of pollution by volume of emissions. To obtain this data amount of (emissions by mass), measurement of the flow rate at the outlet of the after-treatment system is generally used (as it is the case of the PEMS system), which makes the measurement system complex, bulky and costly.

### SUMMARY OF THE INVENTION

The invention determines the (absolute) amount of emissions, in a simple, compact and inexpensive manner. The present invention therefore relates to a method of determining vehicle pollutant emissions, using an on-board measurement system with a sensor and a computer system including a generic model of the vehicle. The method is based on the use of measurements and of the model to determine the amount of pollutants. It avoids the need for a flow rate measurement system by determining the amount of carbon dioxide from the generic model of the vehicle.

The invention relates to a method of determining the pollutant emissions of a vehicle that has travelled a route, the vehicle comprising an internal-combustion engine and an after-treatment system for the exhaust gas of the engine, the method uses an on-board measurement system including at least one sensor located downstream from the after-treatment system and a computer system for determining the emissions of the vehicle by implementing a generic model of the vehicle. For this method, the following steps are carried out:
a) measuring, by use of the sensor, a volume concentration of the pollutant emissions downstream from the after-treatment system;
b) estimating, by use of the generic model of the vehicle, the consumption of the vehicle;
c) determining mass flow rate of carbon dioxide downstream from the after-treatment system from the estimated consumption of the engine; and
d) determining the emissions downstream from the after-treatment system of the vehicle from the measurement of the volume concentration of the emissions and a determined mass flow rate of carbon dioxide.

According to an embodiment, the pollutant emissions of the vehicle are determined from a formula: Qₚₒₗ=Rₘₑₛ×K×Q_{CO2_est}, with Qₚₒₗ being the amount of emissions, Rₘₑₛ being the measured volume concentration of the emissions, K being a coefficient based on a ratio of molar masses of the pollutants considered and of the carbon dioxide, and Q_{CO2_est} which is an estimated carbon dioxide mass flow rate.

According to an implementation, the generic model of the vehicle comprises a model of the vehicle, a model of engine type of the vehicle and an after-treatment model of the vehicle, the vehicle model relating at least one of the position, altitude and speed of the vehicle to torque and to speed of the engine, the model of engine type relating the torque and the speed of the engine to emissions at an outlet of the engine, and the after-treatment model relating the emissions at the outlet of the engine to the emissions at the outlet of the after-treatment system.

According to an aspect of the invention, the on-board system comprises a sensor selected from among a nitrogen oxides NOx sensor, a nitrogen monoxide NO sensor, a nitrogen dioxide NO₂ sensor, a carbon monoxide CO sensor or a carbon dioxide CO₂ sensor, a dioxygen O₂ sensor, an unburned hydrocarbon sensor, an ammonia NH₃ sensor, and a particle sensor.

Preferably, the on-board system comprises a sensor plugged into the diagnostics port of the vehicle, the at least one sensor communicating with the sensor plugged into the diagnostics port of the vehicle by use of a wireless connection.

Advantageously, the computer system comprises at least one of a smartphone, and the at least one sensor communicating with the smartphone by a wireless connection.

Advantageously, at least one of the generic model of the vehicle contained in the computer system is stored on a cloud, the smartphone and the sensor plugged into the diagnostics port of the vehicle which are configured to exchange with the cloud.

According to a feature, the generic model of the vehicle further depends on at least one macroscopic parameter (PAR) of the vehicle, the macroscopic parameter being preferably acquired from at least one of a database (BDD) and an interface with a user.

Furthermore, the invention relates to a method of determining a dynamic compliance factor of the pollutant emissions of a vehicle by use of the on-board measurement system, wherein the following steps are carried out:
a) determining the pollution emissions of the vehicle by use of the method of determining pollution emissions according to one of the above features;
b) constructing a nominal model of the vehicle from at least one macroscopic parameter of the vehicle by use of a machine learning algorithm, the nominal model of the vehicle corresponds to a theoretical model of the generic model of the vehicle; and
c) determining the dynamic compliance factor by comparison of a nominal emissions value Q_{pol nom} determined by use of the nominal model and of an emissions value Q_{pol mes} determined from the method of determining emissions according to one of the above features.

The invention also relates to a method of determining a dynamic compliance factor of the pollutant emissions of a vehicle by use of the on-board measurement system, wherein the following steps are carried out:
a) determining the emissions of pollutants from the vehicle by use of the method of determining emissions of pollutants according to one of the above features,
b) constructing a nominal model of the vehicle from at least one macroscopic parameter of the vehicle by use of a machine learning algorithm, the nominal model of the vehicle corresponds to a theoretical model of the generic model of the vehicle;
c) constructing a calibrated model of the vehicle from the determined emissions of pollutant, from measurements of the sensor and from data from the generic model of the vehicle by use of a machine learning algorithm, the calibrated model of the vehicle corresponding to the generic model of the vehicle calibrated with the measurements of the sensor of the on-board measurement system; and
d) determining the dynamic compliance factor by comparison of an estimation of emissions of pollutants obtained for the calibrated model Q_{pol cal} of the vehicle and of an estimation of the emissions of pollutants obtained for the nominal model Q_{pol nom} of the vehicle for the route travelled by the vehicle.

According to an embodiment, a dynamic compliance factor is determined by comparison of the emissions of pollutants measured by another measurement system and of the estimated emissions of pollutants estimated by use of the nominal model of the vehicle for the route travelled by the vehicle.

Advantageously, the macroscopic parameter used for constructing the nominal model comprises the homologation standard of the vehicle.

According to an aspect, a dynamic compliance factor is determined per segments of the route travelled by the vehicle, notably each route segment has an identical length, preferably the length of the route segment ranges between 1 and 50 km.

According to an implementation of the invention, the method comprises an additional step of determining a dynamic compliance factor for a predetermined theoretical driving cycle by use of the nominal and calibrated models of the vehicle.

According to an optional embodiment, the additional step of determining the compliance factor is repeated for predetermined theoretical driving cycles, and the driving cycle with the highest dynamic compliance factor is identified.

Furthermore, the invention relates to a method of identifying at least one most polluting vehicle, wherein the following steps are carried out:
a) implementing the method of determining a dynamic compliance factor according to one of the above features for the vehicles, and
b) comparing the highest compliance factor for each vehicle in order to determine the at least one most polluting vehicle.

### BRIEF DESCRIPTION OF THE DRAWINGS

Other features and advantages of the method according to the invention will be clear from reading the description hereafter of embodiments given by way of non-limitative example, with reference to the accompanying figures wherein:

FIG. 1 illustrates the steps of the method according to an embodiment of the invention.

FIG. 2 illustrates an on-board measurement system that can be used by the method according to an embodiment of the invention.

FIG. 3 illustrates an on-board measurement system that can be used by the method according to a second embodiment of the invention.

FIG. 4 illustrates the steps of the method according to a second embodiment of the invention.

FIG. 5 illustrates the steps of the method according to a third embodiment of the invention.

FIG. 6 illustrates the steps of the construction of a calibrated model according to an example embodiment of the invention.

FIG. 7 illustrates the NOx emissions for an example of a travelled route, the pollutant emissions being determined by reconstructing the amount of emissions by mass and by use of an emissions value determined for a nominal behavior of the vehicle on the same route;

FIG. 8 illustrates the dynamic compliance factor for the travelled route of the example of FIG. 7 by use of the method of determining a dynamic compliance factor according to the invention.

### DETAILED DESCRIPTION OF THE INVENTION

The present invention relates to a method of determining emission of pollutants for a vehicle that has travelled at least one route.

The term “pollutants” designates nitrogen oxides (NOx), nitrogen monoxide (NO) and nitrogen dioxide (NO₂) (the last two can advantageously be measured individually), particles, carbon monoxides (CO), carbon dioxides (CO₂), unburned hydrocarbons (HC) and ammonia (NH₃). The method according to the invention allows determination of the emissions of at least one, advantageously more and preferably all of these pollutants.

The vehicle comprises an internal-combustion engine (referred to as “engine” hereafter) and an after-treatment system for the exhaust gas of the engine. The internal-combustion engine can be a gasoline engine or a diesel engine, or an engine running on any other type of fuel. The engine can achieve propulsion of the vehicle alone or it can be part of a hybrid propulsion system. The after-treatment system allows treating the pollutant emissions at the engine outlet, thus reducing the pollutant emissions of the vehicle. The after-treatment system can include at least one of a three-way catalyst for simultaneously treating the unburned hydrocarbons, the carbon monoxide and the nitrogen oxides, an oxidation catalyst for treating the unburned hydrocarbons and the carbon monoxide, and DeNOx catalysts for reducing the nitrogen oxides in the presence of oxygen, and various filters for removing the solid particles.

The method of determining emission of pollutants uses an on-board emissions measurement system. The term “on-board” indicates that the system is mounted on board the vehicle, which also implies that the system can be attached outside the vehicle.

The method according to the invention and the on-board measurement system can be used for motor vehicles. However, they can also be used for road transport, two-wheelers, the rail sector, the naval sector, the aeronautics sector, for hovercraft and amphibious vehicles, etc.

The on-board measurement system according to the invention comprises:
at least one sensor located at the outlet of the after treatment system, the sensor is designed to measure the volume concentration of a gas or of particles at the after-treatment system outlet, and
a computer system for determining the pollutant emissions, the computer system therefore executes a generic model of the vehicle.

The generic model of the vehicle is a model representative of the vehicle configured to account for a signal from the sensor(s) in order to determine value of emissions. Using models allows determination of emissions while limiting the number of sensors, involving a cost reduction and a reduction in the measurement system maintenance phases, and to make the on-board measurement system readily transportable and adaptable for all types of vehicles.

The generic model of the vehicle can be of any type.

According to an embodiment of the invention, the generic model of the vehicle can comprise three configured models that can be executed using a waterfall or series approach:
a model of the vehicle, which relates at least one of position, altitude and the speed of the vehicle to the engine torque and speed,
an engine type model of the vehicle, which relates the engine torque and speed to the emissions at the engine outlet, and
an after-treatment model, which relates pollution of emissions at the engine outlet to the emissions at the after-treatment system outlet.

According to an example embodiment of the invention, the generic model of the vehicle can be in accordance with the models described in patent application FR-3,049,653 (WO-17,174,239). These three models are not described in detail in the present application and are incorporated by reference. For a detailed description of these models, reference may be to patent application FR-3,049,653 (WO-17,174,239), in particular to
page 8, line 29, to page 10, line 10, for the vehicle model,
to page 10, line 11, to page 12, line 24, for the engine type model, and to
page 12, line 26, to page 13, line 26, for the after-treatment model.

According to an embodiment of the invention, the three models of the computer system can be dependent on macroscopic parameters of the vehicle. Thus, the models best represent the vehicle, the engine type and the after-treatment system. A macroscopic parameter is understood to be a general feature relative to at least one of the vehicle, the engine and the after-treatment system thereof. Such parameters are constant parameters for a vehicle, corresponding to vehicle manufacturing data. These parameters are referred to as “macroscopic” because they are determined at the scale of the vehicle, and are not a microscopic parameter that can be determined, as in patent application FR-2,984,557 corresponding to US published patent application 2013-0,158,967 for example, at the scale of a grid cell representing a small portion of the combustion chamber.

The macroscopic parameters can be of three types:
parameters related to the general construction of the vehicle (for example: vehicle mass, transmission, . . . ),
parameters related to the engine (for example: injection type, displacement, engine type, . . . ), and
parameters related to the after-treatment system (for example: after-treatment type).

According to an embodiment of the invention, it is possible to acquire at least one macroscopic parameter selected from among:
the engine type (gasoline, diesel, . . . )
the level of emissions standard (Euro 1, Euro 2, . . . )
the engine displacement
the maximum torque and the associated engine speed
the maximum power and the associated engine speed
the vehicle mass
the vehicle transmission type (gearbox type and buildup, . . . )
the after-treatment system type
the injection system type
the air loop architecture (presence/absence of burnt gas recirculation EGR, use of a turbocharger, of supercharging, . . . )
the dimensions of the wheels, etc.

According to a variant embodiment, the macroscopic parameters can be obtained from a database listing the various vehicles in service. For example, the macroscopic parameters can be obtained by use of the registration number of the vehicle, the database associating the license plate number with the design thereof (make, model, engine type, . . . ), and comprising the macroscopic parameters of the vehicle. According to an example embodiment, the database can be stored in the cloud of the computer system.

Alternatively, the macroscopic parameters can be manufacturing data provided by the user, in particular by use of an interface (a smartphone or a geolocation system for example).

According to an embodiment of the invention, the computer system of the on-board measurement system can comprise a smartphone. Such a smartphone provides ease of installation in the vehicle, adaptability, transportability, and cost reduction in relation to a dedicated computer or calculator. Furthermore, a smartphone allows the system to be used by a wide audience.

Optionally, the on-board measurement system can comprise a sensor that is plugged into the OBD (On-Board Diagnostics) port of the vehicle and can recover values such as the engine speed, the engine temperature, the water temperature or the vehicle speed. In the rest of the description below, this sensor is referred to as OBD sensor. The computer can then be designed to account for the values obtained by the OBD sensor. Such an OBD sensor can comprise at least one of a wireless connection (GSM and/or Wi-Fi and/or Bluetooth for example), a geolocation sensor (of GPS type for example). Such a sensor equipped with connection allows a reduction of equipment, which is simple and compact, with improved measurement precision, and also enables as being without a smartphone.

In order to facilitate mounting on board the vehicle (absence of specific wires), the sensor(s) can communicate with the smartphone or the OBD sensor by use of a wireless connection, of Wi-Fi or Bluetooth type for example. In a variant, a wired connection can be provided between the sensor and at least one of the smartphone, the OBD sensor, a computer or a calculator.

Besides, the three models of the computer system can be stored in a cloud or with an online storage service. This storage allows limiting the memory consumed by the smartphone and using more powerful processors to execute the three models. For this configuration, the smartphone or the OBD sensor is configured to communicate with the cloud by an internet connection. This configuration using both a smartphone or an OBD sensor and the cloud enables simplified use at a reduced cost.

If the smartphone or the OBD sensor is equipped with a geolocation system (GPS), then the smartphone or the OBD sensor can also be configured to measure at least one of the speed, altitude and the position of the vehicle. This position, speed or altitude data can be used in the generic model contained in the computer system, possibly (embodiment with three models) in the vehicle model.

In a variant (for example if the smartphone or the OBD sensor is not provided with a geolocation system), the on-board system can comprise a geolocation sensor that communicates with the smartphone or the OBD sensor.

According to another aspect, the computer system can further comprise a display of the pollutant emissions determined by use of the models in order to inform the vehicle user of the vehicle emissions. For example, the display can be the screen of a smartphone.

Alternatively to the smartphone or the OBD sensor, the computer system can comprise a calculator or a computer that communicates with the sensor(s). This calculator or computer can include the generic model of the vehicle (possibly the three models making up the generic model of the vehicle).

According to the invention, the method of determining emission of pollutants comprises the following steps, which will be detailed in the description below:
1) Measuring the volume concentration of the emissions
2) Estimating the vehicle consumption
3) Determining the carbon dioxide mass flow rate
4) Determining the pollutant emissions

Preferably, the steps can be carried out by use of the on-board measurement system. Advantageously, steps 2) to 4) can be carried out by the computer system of the on-board measurement system.

1) Measuring the Volume Concentration of the Emissions of the Pollutants

This step measures, for at least one pollutant type, by use of the sensor of the on-board measurement system, the volume concentration of the emission of pollutants. Indeed, the sensor(s) of the on-board measurement system do not allow measurement of the absolute amount by mass of emissions downstream from the after-treatment system and only allow measurement of a relative value, namely the volume concentration of the emissions. Preferably, the volume concentration is expressed in a % or in parts per million (ppm).

According to an implementation of the invention, the sensor can be selected from among a nitrogen oxides NOx sensor, a nitrogen monoxide NO sensor, a nitrogen dioxide NO₂ sensor, a carbon monoxide CO sensor or a carbon dioxide CO₂ sensor, a dioxygen O₂ sensor, an unburned hydrocarbon sensor, a particle sensor or an ammonia NH₃ sensor.

Preferably, the on-board measurement system comprises a carbon dioxide CO₂ sensor, a particle sensor and a nitrogen oxides NOx sensor. This configuration provides a good compromise in terms of cost of the on-board system and of measured data for optimum calibration of the models.

In particular, the sensor(s) of the on-board measurement system can be selected from among:
regarding the OBD sensor:
   preferably, a sensor capable of reading the information circulating on the OBD communication network of the vehicle, by use of the diagnostics port, or OBD port, arranged close to the dashboard of the vehicle;
regarding the nitrogen oxides NOx volume sensors:
   preferably, an electrochemical sensor
   an ultraviolet UV sensor
   an infrared IR sensor, or
   a chemiluminescence detector (CLD);
regarding the carbon monoxide or carbon dioxide CO/CO₂ volume sensors:
   preferably, an infrared IR sensor, or
   an ultraviolet UV sensor;
regarding the dioxygen O₂ volume sensors:
   preferably, an electrochemical sensor
   a laser diode measurement
   a paramagnetic sensor, or
   a magneto-pneumatic sensor;
regarding the PM/PN/Opacity sensors:
   preferably, charged particle scattering counting
   induced current measurement counting
   a particle accumulation sensor
   an optical opacimeter (Beer-Lambert principle or Mie scattering)
   condensation nuclei counting
   particle irradiation counting
   an optical or ionic domestic smoke detector
   a BAM (Beta Attenuation Monitor) detector for air quality measurement, or
   a true laser particle counter for air quality measurement.

2) Estimating the Vehicle Consumption

This step estimates, by use of the generic model of the vehicle, the fuel consumption of the vehicle for the travelled route. According to the embodiment where the generic vehicle model comprises a vehicle model, an engine type model and an after-treatment model, the fuel consumption of the vehicle for the travelled route can be obtained at the output of the engine type model.

3) Determining the Carbon Dioxide Mass Flow Rate

This step determines the mass flow rate of carbon dioxide CO₂ downstream from the after-treatment system for the route travelled by the vehicle, from the vehicle consumption estimated in the previous step. Thus, no mass flow rate measurement system is necessary to estimate the amount of CO₂ at the after-treatment system outlet.

According to an embodiment, the mass flow rate of CO₂ can be determined by use of a method based on a representation of the combustion, a carbon balance, and by taking the fuel type into account.

Preferably, the carbon dioxide mass flow rate can be expressed in mass per unit of time, in g/h for example.

4) Determining the Emission of Pollutants

This step determines the emissions of at least one type of pollutant, from the measurement, performed in step 1), of the volume concentration of the emissions downstream from the after-treatment system, and from the carbon dioxide mass flow rate downstream from the after-treatment system determined in step 3). Combining the measurement of the volume concentration and the estimated value of the carbon dioxide mass flow rate allows precise determination of the pollutant emissions, without using a flow rate measurement system downstream from the emissions after-treatment system. Thus, the pollutant emissions are determined using precise, simple, inexpensive and compact device.

According to an embodiment of the invention, the pollutant emissions of the vehicle can be determined by use of a formula of the type: Qₚₒₗ=Rₘₑₛ×K×Q_{CO2_est}, with Qₚₒₗ being the amount of emissions to be determined, Rₘₑₛ being the measured volume concentration (step 1)) of the pollutant emissions, K being a coefficient based on the ratio of the molar masses of the pollutant being considered and of the carbon dioxide, and Q_{CO2_est} being the estimated carbon dioxide mass flow rate estimated in step 3). This formula provides a precise estimation.

Advantageously, the amount of pollutant emissions can be expressed in mass per unit of time, in g/h for example.

According to an embodiment of the invention, the method can comprise an additional step of at least one of storing and displaying the amount of emissions thus determined. This data can be at least one of stored and displayed on board the vehicle on the dashboard, on a stand-alone portable device such as a geolocation device (of GPS type), or a mobile phone (of smartphone type). It is also possible to store and to display this indicator on a website that the driver can visit after driving. Furthermore, the amount of pollutant emissions can be shared with a vehicle control station, a car sharing company, a car rental company, a fleet manager, etc.

Advantageously, the method of determining emission of pollutants according to the invention can be implemented in a simple (notably without a specialist), inexpensive and compact manner.

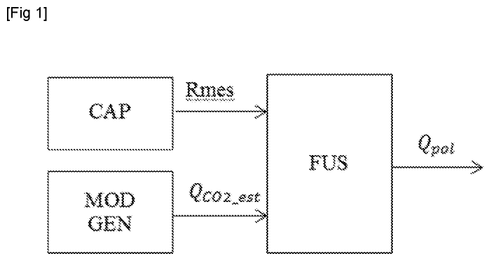

FIG. 1 schematically illustrates, by way of non-limitative example, the method of determining emission of pollutants according to an embodiment of the invention. The following steps are first carried out, simultaneously or successively:
measuring, with a sensor (CAP), a volume concentration Rmes of the emissions downstream from the after-treatment system; and
estimating the mass flow rate of carbon dioxide Q_{CO2_est} by use of the generic model of the vehicle (MOD GEN), and of intermediate step of determining the fuel consumption during the travelled route.

The volume concentration Rmes and the estimated mass flow rate of carbon dioxide Q_{CO2_est} are then combined (FUS) determine the amount of at least one type of pollutant Qₚₒₗ discharged at the after-treatment system outlet.

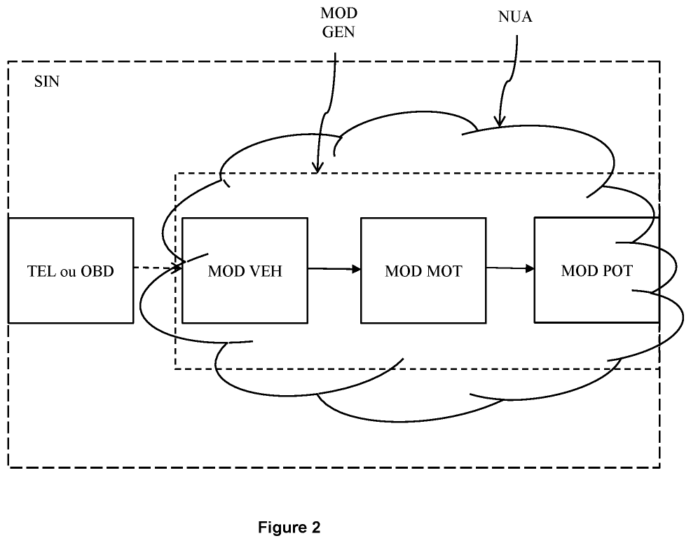

FIG. 2 schematically illustrates, by way of non-limitative example, the computer system of an on-board measurement system for implementing the method of determining emission of pollutants according to an embodiment of the invention. The on-board measurement system comprises a computer system SIN. Computer system SIN includes at least one of a smartphone TEL, an OBD sensor and any similar device equipped with wireless connections (not shown) and a cloud NUA.

In this figure, the arrows in dotted lines correspond to wireless connections between the elements. At least one of a smartphone, the OBD sensor, and any similar device exchanges with cloud NUA through a wireless connection, a GSM (Global System for Mobile communications) connection for example. At least one of the smartphone and/or the OBD sensor transmits a signal to cloud NUA. In particular, at least one of the smartphone TEL and the OBD sensor can transmit a geolocation measurement.

The generic model of the vehicle MOD GEN is stored in cloud NUA. It has three models: a vehicle model MOD VEH, an engine model MOD MOT and an after-treatment model MOD POT. Computer system SIN executes these three models one after the other by use of the data received by the smartphone, in order to determine the pollutant emissions.

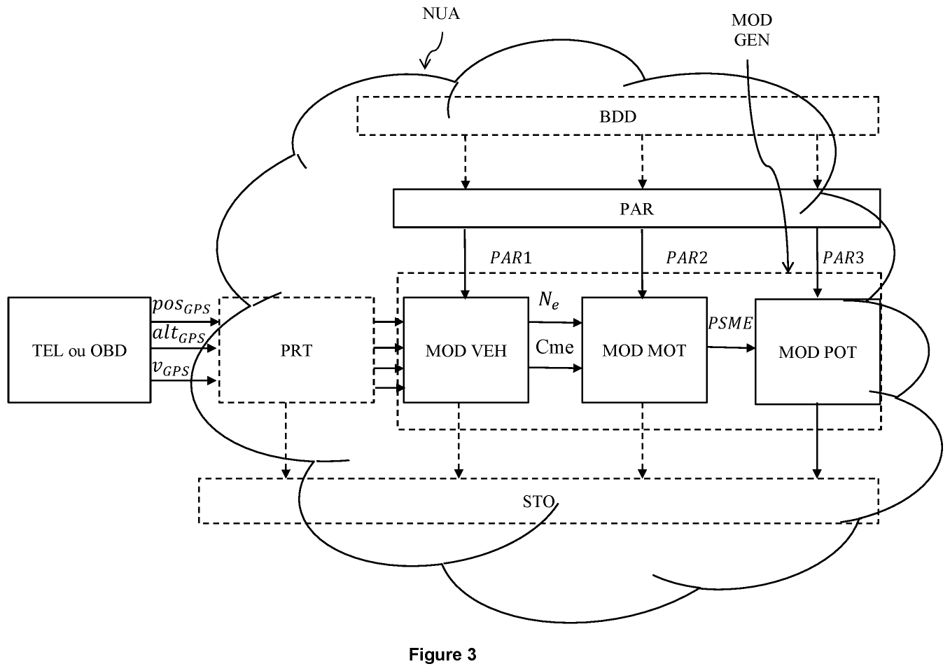

FIG. 3 schematically illustrates, by way of non-limitative example, the use of a computer system of an on-board measurement system for implementing the method of determining emission of pollutants according to an embodiment of the invention. In this figure, the dotted lines indicate the optional elements of the method.

Prior to carrying out the steps of the method, the generic model of the vehicle MOD GEN (comprising here a vehicle model MOD VEH, an engine model MOD MOT and an after-treatment model MOD POT) is constructed. These models are preferably constructed from macroscopic parameters PAR. Optionally, macroscopic parameters PAR can be obtained from a database BDD that lists the various vehicles in circulation. For example, macroscopic parameters PAR can be obtained by entering the vehicle registration number, database BDD associating the license plate number with the design of the vehicle (make, model, engine type, . . . ) and comprising the macroscopic parameters of the vehicle. Database BDD can be stored in cloud NUA of the computer system.

A first series of macroscopic parameters PAR1 can be used for the construction of vehicle model MOD VEH. This first series of macroscopic parameters PAR1 can comprise the following parameters: mass of the vehicle, maximum power and associated engine speed, maximum speed, transmission type (non-limitative list).

A second series of macroscopic parameters PAR2 can be used for the construction of engine model MOD MOT. This second series of macroscopic parameters PAR2 can comprise the following parameters: displacement, engine type, maximum torque and power, air loop architecture, and vehicle homologation standard (non-limitative list).

A third series of macroscopic parameters PAR3 can be used for the construction of after-treatment model MOD POT. This third series of macroscopic parameters PAR3 can comprise the following parameters: displacement, vehicle homologation standard (non-limitative list).

The first step can perform a geolocation measurement step by use of at least one of smartphone TEL, the sensor and any similar use, advantageously an OBD sensor. At least one of the position pos_{GPS}, the altitude alt_{GPS} and the speed v_{GPS} of the vehicle can be measured in this step. Taking into account the altitude alt_{GPS} notably allows the slope of the road to be taken into account. Preferably, the three measurements are performed to have the most precise information possible regarding geolocation of the vehicle, because the driving style and the vehicle acceleration can then be taken into account. This measurement can be made using a geolocation system, for example at least one of GPS (Global Positioning System), Galileo, or by use of a smartphone. In the case of a smartphone, it can be equipped with a geolocation system, alternatively the measurements can be performed by other methods, notably by triangulation.

Furthermore, the first step comprises transmission to cloud NUA of the geolocation measurements.

The second step, which is optional, is a step of preprocessing PRT of the measurement signals. This step allows improvement of the quality of the measured signals prior to using them. It can notably be interesting if the measurements are performed from a smartphone because measurements obtained with such a device can be somewhat imprecise. This preprocessing can be variable as it depends on the quality of the input data. According to an embodiment of the invention, preprocessing PRT can comprise oversampling the signals, then filtering. At the end of this step, signals relative to at least one of position pos_{GPS} altitude alt_{GPS} and speed v_{GPS} of the vehicle are thus available, which have been preprocessed.

The third step determines the engine torque and speed. It is carried out by use of vehicle model MOD VEH, which determines torque Cme and speed Ne of the engine, as a function of the geolocation data: at least one of position pos_{GPS}, altitude alt_{GPS}, and speed v_{GPS} of the vehicle.

The fourth step determines the emissions of pollutants at the engine outlet. This step is carried out by use of engine model MOD MOT, which determines the emission of pollutants at the engine outlet PSME, as a function of torque Cme and speed Ne of the engine.

The fifth step determines the emissions of pollutants of the vehicle, that is at the outlet of the after-treatment system. Determination of emissions can be done at any time, for example at a frequency of 1 Hz. Furthermore, it is also possible to determine the cumulative emissions for a given route. This step is carried out using after-treatment model MOD POT, which determines the emission of pollutants at the outlet of the after-treatment system, as a function of the emissions at the engine outlet PSME.

The sixth step, which is optional, relates to data storage. Once the emission of pollution of the vehicle have been determined, they can be stored STO (recorded), in particular in a database (different from the database comprising the macroscopic parameters). This storage STO can concern only the emissions of pollutants from the vehicle, but it may also concern the data determined after each step of the method: at least one of preprocessed measurements torque Cme, speed Ne of the engine and emission of pollutants at the engine outlet PSME. This information enables monitoring of the real uses and of the associated emissions with good spatial and temporal resolution. Storage STO can be contained in cloud NUA.

Furthermore, the invention relates to a method of determining a dynamic compliance factor for the emissions pollutants of a vehicle for a travelled route. A dynamic compliance factor is understood to be a coefficient indicating the behavior of the vehicle in terms of emissions. This coefficient is the result of a comparison between at least one of theoretical values of emissions, measured and estimated values of emissions. The method of determining a dynamic compliance factor of the emissions of pollutants uses the method of determining emission of pollutants according to any one of the variants of the invention described above.

For this method, the following steps are carried out:
1) Determining the emission of pollutants
2) Constructing a nominal model
3) (Optional step) Constructing a calibrated model
4) Determining a dynamic compliance factor

Preferably, the steps are carried out by use of the on-board measurement system. Advantageously, steps 1) to 4) can be carried out by the computer system of the on-board measurement system.

1) Determining the Emission of Pollutants

This step determines, for at least one type of pollutant, the amount (by mass) of emissions for the route travelled by the vehicle, by use of the method of determining pollutant emissions according to one of the variants or one of the variant combinations described above.

2) Constructing a Nominal Model

This step constructs a nominal model of the vehicle from at least one macroscopic parameter of the vehicle, by use of a machine learning algorithm. The nominal model of the vehicle corresponds to a theoretical model of the generic vehicle model for an ideal operation of the vehicle. In other words, the nominal model of the vehicle is representative of a vehicle without defects consistent with the standard to which it corresponds.

According to an embodiment of the invention, the macroscopic parameter used for constructing the nominal model can be the vehicle homologation standard (for example Euro 4, Euro 5, etc.).

According to an implementation of the invention (that can be combined with the previous embodiment), the macroscopic parameter used for constructing the nominal model can comprise manufacturing data relative to the vehicle.

These macroscopic parameters can be supplemented by information on the use of the vehicle by the driver: for example the engine speed, and the engine load. This information can possibly be obtained by the OBD sensor.

3) Constructing a Calibrated Model

This optional step (used for the third embodiment of the invention) constructs a calibrated model of the vehicle from the determined pollutant emission of pollutants, measurements from the on-board system sensor(s) and data from the generic model of the vehicle. The calibrated model corresponds to the generic model of the vehicle calibrated with the measurements of the sensor. According to the invention, construction of the calibrated model is performed by use of a machine learning algorithm.

Calibration of the generic model can be carried out for several parameters, among which (non-exhaustive list):
the gear ratios of the vehicle,
calibration of the engine warm-up dynamic by use of an engine water temperature,
calibration of the fuel consumption,
calibration of the burnt gas circulation, in the case of a spark-ignition engine (a gasoline engine for example),
the nitrogen oxides NOx value allows light-off/warm-up of the three-way catalyst to be calibrated,
the nitrogen oxides NOx value allows the models related to the NOx reduction catalysts to be calibrated: NOx storage model in the case of a NOx trap, reducing agent (predominantly ammonia) injection and storage model in the case of an SCR (Selective Catalytic Reduction) catalyst,
the measured particles value allows the soot emission models to be calibrated when the engine does not have an exhaust gas filter system,
if the engine has an exhaust gas filter system, measurement of the particles allows to assess the filtration efficiency.

According to an example of implementation of this step, the part of the generic vehicle model representative of the gear box staging can be calibrated by means of data from the OBD sensor and of engine speed signals. For this application, the generic vehicle model can be calibrated by means of the vehicle power and the maximum attainable speed. The gear box staging can first be deduced using conventional design principles. The data from the generic vehicle model then allows to apply a grouping method for identifying the staging ratios and the gear ratios engaged throughout the travelled route.

According to another example of implementation of this step (that can be combined with the first example), this step can implement calibration of the nitrogen oxides NOx estimation at the exhaust for diesel vehicles. For example, to estimate the pollutant emissions downstream from the after-treatment system, the generic vehicle model can rely on a model of the emissions at the engine outlet and on an after-treatment system model. The estimated internal physical quantities can be used to obtain the emissions at the engine outlet, which may notably be nitrogen oxides NOx, particles, carbon monoxide, carbon dioxide. In particular, the NOx emissions at the engine outlet (NOx EO) may depend on the fuel flow rate Q_{fuel} and on the burnt gas ratio BGR in the cylinder, which it can be written as follows:

$$\frac{NOx EO}{{Q}_{fuel}} = {e}^{α * BGR + β}$$

An after-treatment model library has been developed with several sub-models (see after-treatment model in French patent application FR-3,049,653 (WO-17,174,239)). With these sub-models, it is possible to describe most existing exhaust line architectures (after-treatment system). The outputs of these sub-models are the pollutant emissions at the after-treatment system outlet. With the pollutant level required for the vehicle and data fusion with the sub-models, these two elements allow the pollutant estimation at the system outlet to be improved. For example, FIG. 6 shows the steps carried out for constructing the calibrated model for NOx emissions downstream from the after-treatment system. The NOx emissions at the engine outlet (NOx EO), the burnt gas ratio in the cylinder, the average generic efficiency of the after-treatment system (in particular the catalysis system SCR, denoted by SCR Eff generic) and the NOx emissions at the after-treatment system outlet (NOx TP) are determined in the generic model MOD GEN. In parallel, the NOx emissions at the after-treatment system outlet (NOx TP) are measured by use of a sensor CAP. From measurements CAP and the data from generic model MOD GEN, targets CIB are determined for the quantities being considered: a target for the NOx emissions at the engine outlet (NOx EO target), a target for the average efficiency of the after-treatment system (SCR Eff target) and a target for the NOx emissions at the after-treatment system outlet (NOx TP target). These targets are used by a calibration machine learning algorithm CAL by determining a burnt gas fraction offset (BGR offset) and an average efficiency gain of the after-treatment system. For example, a ratio between the average generic efficiency and the average efficiency target allows the model to be calibrated. This step allows obtaining the calibrated model, which determines the NOx emissions at the engine outlet (NOx EO), the burnt gas fraction in the cylinder, the average efficiency of the after-treatment system and the NOx emissions at the after-treatment system outlet (NOx TP) that are consistent with the measurements.

The following equations can be used for these steps:

$$NOx TP target = NOx TP meas$$

$$NOx EO target = NOx EO generic + Prop EO \times \frac{NOx TP target - NOx TP generic}{1 - SCR Eff generic}$$

$$SCR Eff target = 1 - \frac{NOx TP target}{NOx EO target}$$

$${BGR}_{offset} = 1 \text{/} α \times log ( NOx EO target \text{/} NOx EO generic ) \times {K}_{0}$$

where K₀ is a NOx model calibration coefficient and Prop EO is a coefficient representative of the proportion of NOx to be assigned to the engine outlet or to the after-treatment system efficiency variation.

4) Determining a Dynamic Compliance Factor

This step determines a dynamic compliance factor (also named dynamic conformity factor) by comparison between theoretical emission of pollutants values and measured and estimated values of pollutant emissions. The dynamic compliance factor is determined for the route travelled by the vehicle. A high value of the dynamic compliance factor reflects a vehicle whose behavior (in terms of emissions of pollutants) is scarcely compliant with a nominal vehicle (non-defective, failure-free); on the other hand, a low compliance factor value reflects a vehicle whose behavior (in terms of emission of pollutants) is in compliance with the nominal vehicle (non-defective, failure-free). It is therefore possible to determine a failing vehicle by use of the dynamic compliance factor.

Advantageously, a dynamic compliance factor can be determined for each type of pollutants being considered.

According to the second embodiment (for which step 3) is not necessary), the dynamic compliance factor can be determined by comparison of a nominal value of emission of pollutants determined by use of the nominal model and of an estimated value of emissions of pollutants, from the measurements obtained with the on-board system sensor(s), for example by use of the method of determining emission of pollutant according to any one of the variants or variant combinations described above.

For this first variant embodiment, the dynamic compliance factor CF can be calculated, for at least one type of pollutant, by a formula:

$$CF = \frac{{Q}_{pol mes}}{{Q}_{pol nom}} ,$$

with Q_{pol mes} being the amount of pollutant estimated by use of the method for determining emissions from the measurements obtained with the on-board system sensor(s) and Q_{pol nom} being the amount of pollutants estimated with the nominal model.

According to a third embodiment (for which step 3) is not necessary), the dynamic compliance factor can result from a comparison between theoretical values of pollutant emissions obtained with the nominal model and values measured by at least one of the sensor(s) and pollutant emissions estimated with the calibrated model.

For this third embodiment, dynamic compliance factor CF can be calculated, for at least one type of pollutant type, by a formula:

$$CF = \frac{{Q}_{pol cal}}{{Q}_{pol nom}} ,$$

with Q_{pol cal} being the amount of pollutants with the calibrated model and Q_{pol nom} the pollutant amount estimated with the nominal model.

Alternatively, a dynamic compliance factor CF can be determined by comparison of theoretical pollutant emissions values obtained with the nominal model and values measured with another measurement system (PEMS for example). In this case, the dynamic compliance factor can be calculated, for at least one type of pollutant, by a formula:

$$CF = \frac{{Q}_{pol mes}}{{Q}_{pol nom}} ,$$

with Q_{pol pems} being the amount of pollutant measured with another measurement system and Q_{pol nom} being the amount of pollutant estimated with the nominal model.

According to an embodiment, the dynamic compliance factor can be determined for the travelled route.

Additionally or alternatively, the dynamic compliance factor can be determined for at least one segment of the travelled route (that is a portion of the travelled route). Thus, the dynamic compliance factor can be determined for a single type of road (urban, extra-urban, motorway, etc.). Preferably, the dynamic compliance factor can be determined for each segment of the travelled route, in order to determine the behavior of the vehicle over the entire route. Advantageously, the route segment can have a constant length, ranging between 1 and 50 km, advantageously between 5 and 25 km, preferably between 10 and 20 km so as to be representative of a road type.

According to an aspect of the invention, this step can comprise an additional sub-step of determining at least one dynamic compliance factor for at least one theoretical driving cycle by use of the calibrated and nominal models. It determines a dynamic compliance factor for a driving cycle that has not been travelled by the vehicle. The theoretical driving cycle can be a homologation driving cycle or an emissions test driving cycle (for example a Real Driving Emissions RDE cycle). It is thus possible to obtain data relative to the polluting behavior of the vehicle for other driving conditions.

Advantageously, the method can comprise repeating the sub-step of determining at least one dynamic compliance factor for several driving cycles, then identifying the driving cycle for which the compliance factor is the highest. It is thus possible to determine the worst case (i.e. the worst driving cycle) where the vehicle has a behavior (in terms of pollutant emissions) far remote from the nominal vehicle (failure-free).

Preferably, for this implementation of the invention, the dynamic compliance factor can be determined according to the third embodiment of the invention, which is by comparison of the emissions of pollutant estimated by the calibrated model and by the nominal model. Using the calibrated model with a travelled route provides an estimation representative of the vehicle for other driving cycles (that have not been performed). Thus, by means of the model calibrated with measured data, the dynamic compliance factor is precise even for a theoretical driving cycle.

According to an embodiment of the invention, the method can comprise an additional step of at least one of storing and displaying the determined dynamic compliance factor(s). At least one of storage and display can be achieved on board the vehicle: on the dashboard, a stand-alone portable device, such as a geolocation device (of GPS type), a mobile phone (of smartphone type). It is also possible to store and to display this indicator on a website that the driver can visit after driving. Furthermore, the dynamic compliance factor(s) can be shared with a vehicle control station, a car sharing company, a car rental company, a fleet manager, etc.

Moreover, the present invention relates to a method of identifying at least one very polluting vehicle. The following steps are carried out for this method:
a) implementing the method of determining a dynamic compliance factor over several theoretical driving cycles according to any one of the variants or variant combinations described above, for multiple vehicles, and
b) comparing the highest dynamic compliance factor of each vehicle and determining therefrom the most polluting vehicle(s).

This method allows identification of the most polluting vehicle(s) from among a fleet of vehicles. This identification then allows selection of the vehicle(s) for which more complete tests need to be performed (PEMS type tests for example), thereby avoiding long, costly and complex tests for vehicles that do not need them.

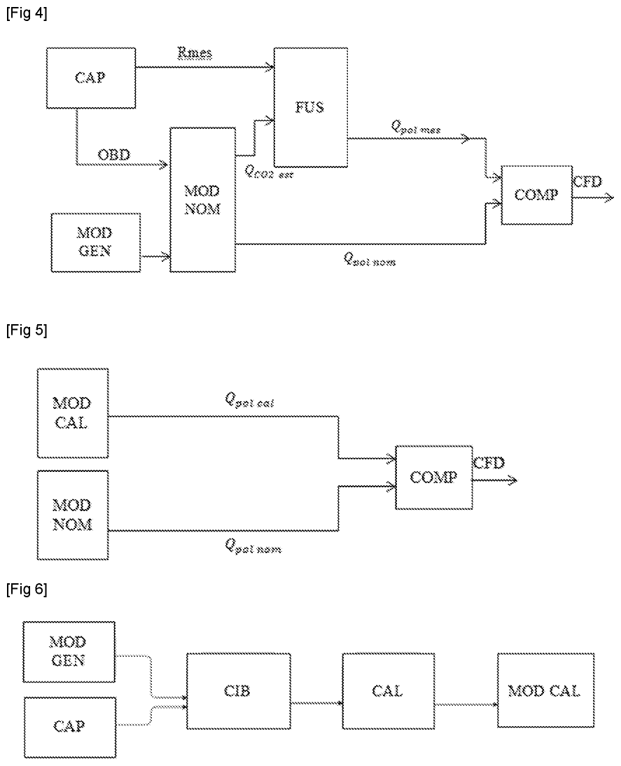

FIG. 4 schematically illustrates, by way of non-limitative example, the steps of the method for determining a dynamic compliance factor according to the second embodiment. The lower part of the figure shows the construction of nominal model MOD NOM, based on generic model MOD GEN and on a macroscopic parameter (the homologation standard of the vehicle for example). As shown, the construction of nominal model MOD NOM can further take into account the signal from an OBD sensor. As in FIG. 1, nominal model MOD NOM allows determination of the amount of CO₂: Q_{CO2} at the after-treatment system outlet. This datum is used with measurement Rmes from sensor CAP to determine the pollutant amount Q_{pol mes} in a data fusion (reconstruction) step FUS. The pollutant emissions at the output of nominal model MOD NOM are denoted by Q_{pol nom} and they are subsequently compared COMP with the pollutant amount Q_{pol mes} estimated by means of the method of determining emissions according to the invention in order to determine dynamic compliance factor CFD.

FIG. 5 schematically illustrates, by way of non-limitative example, the steps of the method for determining a dynamic compliance factor according to a third embodiment. For this embodiment, nominal model MOD NOM is constructed in a manner similar to the first variant embodiment of FIG. 4. Furthermore, calibrated model MOD CAL is constructed by use of the generic model (not shown) and of the measurements (not shown). Nominal model MOD NOM allows determination of a nominal emissions amount Q_{pol nom}. Calibrated model MOD CAL allows determination of a calibrated emissions amount Q_{pol cal}. These two amounts of pollutant emissions are subsequently compared COMP so as to determine dynamic compliance factor CFD.

### EXAMPLE

The features and advantages of the method according to the invention will be clear from reading the application example hereafter.

The example relies on the test of a Euro 6b vehicle. The method of determining a dynamic compliance factor is applied for a distance of about 90 km travelled by the vehicle. A dynamic compliance factor is determined for every 10-km segment of the route travelled.

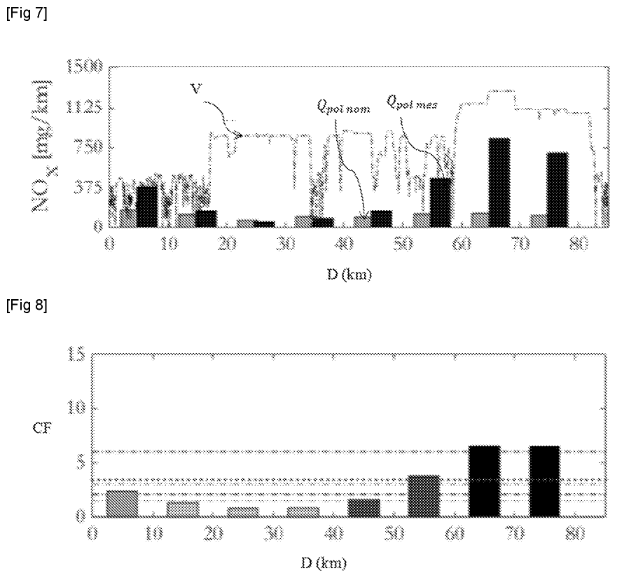

FIG. 7 illustrates the speed profile V in dotted line and the estimated NOx emissions (in mg/km) as a function of the distance D in km travelled by the vehicle. The NOx emissions are represented by a histogram: the light grey rectangles correspond to the NOx emissions estimated with the nominal model Q_{pol nom} and the dark grey rectangles correspond to the NOx emissions estimated with the method of determining emission of pollutants according to the first embodiment of FIG. 1, denoted by Q_{pol mes}. The speed profile is varied: it comprises a first low-speed section that may correspond to an urban route (10 to 20 km), a second average-speed section that may correspond to an extra-urban route (20 to 60 km) and a third high-speed section that may correspond to a motorway route (60 to 90 km). It is noted that the NOx estimations differ depending on the model used and on the speed of the vehicle. It is notably observed that the vehicle has a cold start with higher pollutant emissions than those expected Q_{pol nom}, that the vehicle has pollutant emissions corresponding to those expected Q_{pol nom} over the second route section and that the vehicle is faulty in terms of emissions for the third high-speed route section.

FIG. 8 illustrates a histogram of dynamic compliance factor CF as a function of distance, constructed from the data of FIG. 7. Dynamic compliance factor CF is obtained by use of the first variant embodiment (see FIG. 4) by the ratio of the estimated NOx amount Q_{pol mes} to the NOx amount estimated with the nominal model Q_{pol nom}. This histogram corroborates the analysis of FIG. 7: the vehicle studied is faulty in terms of emissions for the third high-speed route section.

1-16. (canceled)

17. A method of determining emission of pollutants for a vehicle that has travelled a route, the vehicle comprising an internal-combustion engine and an after-treatment system for exhaust gas from the engine, the method utilizing an on-board measurement system including at least one sensor located downstream from the after-treatment system and a computer system for determining the emission of pollutants of the vehicle by utilizing a generic model of the vehicle, comprising steps:
a) measuring, by use of the at least one sensor, a volume concentration of the emission of pollutants downstream from the after-treatment system;
b) estimating, by use of the generic model of the vehicle, fuel consumption of the vehicle;
c) determining a mass flow rate of carbon dioxide downstream from the after-treatment system from the estimated fuel consumption of the engine; and
d) determining emissions downstream from the after-treatment system of the vehicle from the measurement of the volume concentration of the emission of pollutants and the determined mass flow rate of carbon dioxide.

18. A method of determining emission of pollutants as claimed in claim 17, wherein the emission of pollutants of the vehicle are determined from a formula: Qₚₒₗ=Rₘₑₛ×K×Q_{CO2_est}, with Qₚₒₗ being an the amount of emission of pollutants, Rₘₑₛ being the measured volume concentration of the emission of pollutants, K being a coefficient based on a ratio of molar masses of the emission of pollutants that were considered and of the carbon dioxide, and Q_{CO2_est} being an estimated carbon dioxide mass flow rate.

19. A method of determining emission of pollutants as claimed in claim 17, wherein the generic model of the vehicle comprises a model of the vehicle (MOD VEH), a model of the engine type (MOD MOT) of the vehicle and an after-treatment model (MOD POT) of the vehicle, the vehicle model (MOD VEH) relating at least one of the position, altitude, and speed of the vehicle to torque and to the speed of the engine, the engine type model (MOD MOT) relating the torque and the speed of the engine to emissions at the outlet of the engine and the after-treatment model (MOD POT) relating the emissions at the outlet of the engine to the emissions at the outlet of the after-treatment system.

20. A method of determining pollutant emissions as claimed in claim 17, wherein the on-board system comprises a sensor selected from among a nitrogen oxides NOx sensor, a nitrogen monoxide NO sensor, a nitrogen dioxide NO₂ sensor, a carbon monoxide CO sensor or a carbon dioxide CO₂ sensor, a dioxygen O₂ sensor, an unburned hydrocarbon sensor, an ammonia NH₃ sensor, and a particle sensor.

21. A method of determining pollutant emissions as claimed in claim 17, wherein the on-board system comprises a sensor plugged into a diagnostics port of the vehicle (OBD), the at least one sensor (CAP) communicating with the sensor plugged into the diagnostics port of the vehicle (OBD) by a wireless connection.

22. A method of determining pollutant emissions as claimed in claim 17, wherein the computer system comprises at least one of a smartphone and the at least one sensor communicating with the smartphone by a wireless connection.

23. A method of determining pollutant emissions as claimed in claim 21, wherein the generic model of the vehicle contained in the computer system is stored in at least one of a cloud, the smartphone, and the sensor plugged into the diagnostics port of the vehicle being configured to exchange information with the cloud.

24. A method of determining pollutant emissions as claimed in claim 17, wherein the generic model of the vehicle further depends on at least one macroscopic parameter of the vehicle, the at least one macroscopic parameter being acquired from at least one of a database and an interface with a user.

25. A method of determining a dynamic compliance factor of pollutant emissions of a vehicle by use of the on-board measurement system, comprising steps of:
a) determining the pollutant emissions of the vehicle by a method of determining pollutant emissions according to claim 17,
b) constructing a nominal model of the vehicle from at least one macroscopic parameter of the vehicle by use of a machine learning algorithm and a nominal model of the vehicle corresponding to a theoretical model of the generic model of the vehicle; and
c) determining a dynamic compliance factor by a comparison of a nominal emissions value determined by use of the nominal model and of an emissions value determined from the method of determining emissions according to claim

17.

26. A method of determining a dynamic compliance factor of the pollutant emissions of a vehicle by use of an on-board measurement system, wherein the following steps are carried out:
a) determining the pollutant emissions of the vehicle by use of the method of determining pollutant emissions according to claim 17;
b) constructing a nominal model of the vehicle from at least one macroscopic parameter of the vehicle by use of a machine learning algorithm, the nominal model of the vehicle corresponding to a theoretical model of the generic model of the vehicle;
c) constructing a calibrated model of the vehicle from the determined pollutant emissions, from measurements of the sensor and from data from the generic model of the vehicle by use of a machine learning algorithm, the calibrated model of the vehicle corresponding to the generic model of the vehicle calibrated with measurements of a sensor of the on-board measurement system; and
d) determining a dynamic compliance factor by comparison of an estimation of the pollutant emissions obtained for the calibrated model of the vehicle and of an estimation of the pollutant emissions obtained for the nominal model of the vehicle for the route travelled by the vehicle.

27. A method of determining a dynamic compliance factor as claimed in claim 26, wherein a dynamic compliance factor is determined by comparison of the pollutant emissions measured by another measurement system and of the pollutant emissions estimated by use of the nominal model of the vehicle for the route travelled by the vehicle.

28. A method of determining a dynamic compliance factor as claimed in claim 26, wherein a macroscopic parameter used for constructing the nominal model comprises a homologation standard of the vehicle.

29. A method of determining a dynamic compliance factor as claimed claim 26, wherein a dynamic compliance factor is determined per segment of the route travelled by the vehicle, each route segment having an identical length, with length of a route segment ranging between 1 and 50 km.

30. A method of determining a dynamic compliance factor as claimed claim 26, wherein the method comprises an additional step of determining a dynamic compliance factor for a predetermined theoretical driving cycle by use of a nominal and calibrated models of the vehicle.

31. A method of determining a dynamic compliance factor as claimed in claim 30, wherein the additional step of determining the compliance factor is repeated for predetermined theoretical driving cycles, and a driving cycle with a highest dynamic compliance factor is identified.

32. A method of identifying at least one most polluting vehicle, comprising steps of:
a) implementing the method of determining a dynamic compliance factor as claimed in claim 31 for multiple vehicles; and
b) comparing a highest compliance factor for each vehicle in order to determine the at least one most polluting vehicle.
